(19) United States
(12) Patent Application Publication
(10) Pub. No.: US 2002/0003478 A1
(43) Pub. Date: Jan. 10, 2002

(54) Infant monitoring system

(76) Inventors: Xiaode Zhao, Beijing (CN); Feng Han, Beijing (CN)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 09/898,217

(22) Filed: Jul. 3, 2001

(30) Foreign Application Priority Data
Jul. 5, 2000 (CN) 00243202.1

(51) Int. Cl. G08B 23/00

(52) U.S. Cl. 340/573.1; 340/604

(57) ABSTRACT

A monitoring system for detecting the breathing and wetness status of an infant or the like comprises a breathing sensor for monitoring breathing rhythms of the infant; a urinary wetness sensor for detecting urination of the infant; and a processing device. The processing device contains a radio transmission module for sending a radio alarm signal to at least one remote receiver, and a circuit board for receiving and analyzing sensed data from the breathing sensor and the urinary wetness sensor. When sensed data reaches an associated threshold, the circuit board will activate an audible-visual alarm circuit to produce an alarm at the site of the infant and drive the radio transmission module to send out a radio alarm signal to remote receivers.

### TECHNICAL FIELD

The present invention relates to a multi-function system for monitoring the status of an infant, and more particularly to an apnea and urinary wetness detecting system which can generate an alarm signal and transmit it to remote receivers.

### BACKGROUND OF THE PRESENT INVENTION

Breathing is essential to life. Normal and continuous breathing is an important symbol of health. Clinical medical data shows that apnea or cessation of breathing can occur in infants having an incomplete breathing center. If apnea is not noted and treated immediately, the continued lack of oxygen may cause the necrosis of the infant's brain cells and may even result in the infant's sudden death.

It is also important for the health of an infant that its diaper be changed promptly when it is wet as the very delicate skin of an infant's buttocks is prone to inflammation caused by wetness. A slight inflammation may cause an itch which can affect the infant's sleep. In addition, if the inflammation is left untreated, a severe infection or septicemia may develop that might endanger the infant's life. Therefore, it is desirable that a monitoring system be utilized for monitoring an infant that is capable of detecting both apnea, which can cause the sudden death of the infant, and urination, which can lead an infection and possible septicemia.

### SUMMARY OF THE PRESENT INVENTION

It is therefore a principle object of the present invention to provide an infant monitoring system for detecting apnea and urinary wetness, and providing an indication of either condition, e.g., by activating an alarm.

A further object of the present invention is to provide an infant monitoring system that can produce audible-visual alarm at the site of the infant and transmit signals to remote receivers.

It is still a further object of the present invention to utilize coded signals so as to reduce the likelihood of false alarms at the remote receivers.

It is yet another object to provide an infant monitoring system which is reliable and easy to use.

In accordance with a disclosed embodiment of the present invention, a reliable, convenient infant monitoring system is provided that is capable of detecting both apnea and urinary wetness of an infant. Advantageously, one integrated device is used, and either detected condition generates an alarm signal. Such signal, in the form of an audible and/or visible alarm, may be provided at a local site, i.e., one proximate to the infant, and/or transmitted to a site that is remote from the infant. The above-described system is also applicable for use with others, such as the elderly and infirm who are unable to care for themselves.

### BRIEF DESCRIPTION OF THE DRAWINGS

FIG. 1 is a perspective view of an infant monitoring system including a processing device and a radio receiver in accordance with the present invention.

FIG. 2 is a block diagram of the processing device and radio receiver of FIG. 1.

FIG. 3 is a block diagram showing the operation of transmitting and receiving coded signals in accordance with a disclosed embodiment of the present invention.

FIG. 4 is a circuit diagram of the circuit board in the processor of FIG. 1.

### DETAILED DESCRIPTION OF A PREFERRED EMBODIMENT

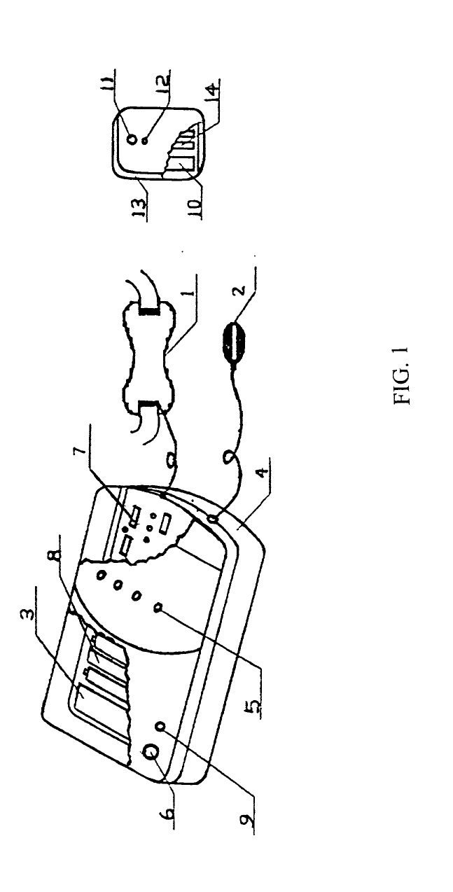

Refer to FIG. 1. An exemplary embodiment of an infant monitoring system in accordance with the present invention includes processing device 4, breathing sensor 1, urinary wetness sensor 2 and radio receiver 13. Processing device 4 comprises a circuit board 7 for receiving and analyzing sensed data from breathing sensor 1 and urinary wetness sensor 2, and a radio transmission module 3 for sending a radio alarm signal. It also contains a set of batteries 8, a power source switch 6, a DC voltage indication light 9 and infant status indication lights 5. Radio receiver 13, comprising radio receiving module 10, battery 14, power source switch 11 and indication light 12, is designed for receiving a radio signal from processing device 4 and then activating an audible-visual alarm. It can be seen that breathing sensor 1 and urinary wetness sensors 2 are respectively connected to processing device 4, which continuously collects and analyzes sensed data about the status of the infant. If any abnormal status of an infant is detected, processing device 4 will generate an alarm by activating an indication light and a buzzer. In addition, a radio signal will be transmitted to one or more remote receivers.

In a preferred embodiment of the present invention, breathing sensor 1 is a strain type. A strain sheet is placed on an elastomer. The elastomer, together with the strain sheet, is housed inside a soft enclosure that is applied to an infant's abdomen with a strap. The breathing rhythm of an infant is then detected by sensing variations in the curvature of the infant's abdomen. The wetness sensor, on the other hand, makes use of the fact that urine conducts electrical signals. The urinary wetness sensor 2 operates by detecting the variations in the resistance of a resistor produced by the urine and then sending a indicative of such variations to processing device 4 for analyzing.

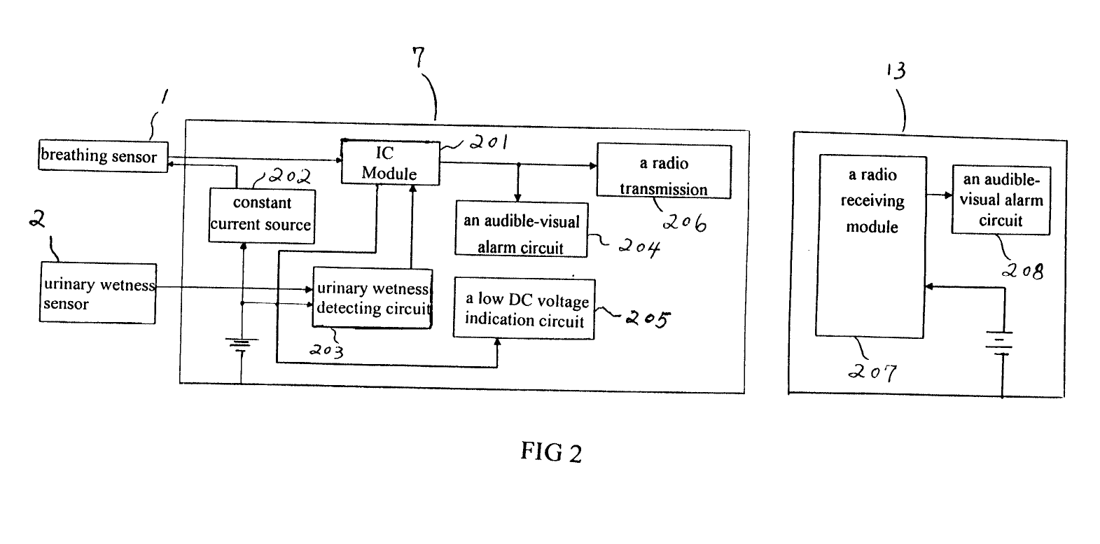

As shown in FIG. 2, circuit board 7 includes an integrated circuit (“IC”) module 201, a constant current source circuit 202, a urinary wetness detecting circuit 203, an audible-visual alarm circuit 204, a low DC voltage indication circuit 205 and a radio transmission module 206. The output of breathing sensor 1 is fed to an input of the IC module 201. Another input into the IC module is a sensed signal from urinary wetness sensor 2 via the urinary wetness detecting circuit 203. One of the outputs of the IC module is fed to the audible-visual alarm circuit 204 and to the radio transmission module 206 to generate and transmit an alarm. Another output of the IC module 201 is coupled to the low DC voltage indication circuit 205 for activating an indication light. The constant current source circuit 202 provides breathing sensor 1 with a constant current.

The IC module 201, in the exemplary embodiment of the present invention, is module designated as “HS01” and produced by the Beijing Fengyang Science & Technology Development Co. Ltd., Beijing, China. Module HS01 can detect a sensed signal from breathing sensor 1 at a rate of 5 times per second, and can store the results as data in its memory for 15 seconds. After this time period, the stored data is updated with new data. HS01 monitors and analyzes the status of an infant by comparing newly detected data from the breathing sensor 1 with previously stored data from such sensor. If an analysis shows no variation in the curvature of the infant's abdomen, indicating that the abdomen of the infant has no motion and that breathing has stopped, an alarm signal will be activated by module HS01. This signal drives the audible-visual alarm circuit 204 to sound an alarm and the radio transmission module 206 to send a radio alarm signal. In addition, when the breathing rhythm of the infant exceeds 60 times per minute, indicating quicker breathing than normal, module HS01 will also generate an alarm signal.

If none of above circumstances happens, module HS01 will send out a signal indicating that the infant is in a normal condition. Accordingly, a breathing indication light will alternate between on and off in synchronism with the infant's breathing.

Similarly, module HS01, through the urinary wetness detecting circuit 203, analyzes the signal from urinary wetness sensor 2. When urination of the infant is detected, it will activate the audible-visual alarm circuit 204 to produce an alarm and drive the radio transmission module 206 to send a radio alarm signal.

Radio receiver 13 includes a receiving module 207 for receiving the radio signal transmitted from processing device 4 and an audible-visual circuit 208 for sounding an alarm. Accordingly, the radio receiver 13 may drive its own audible-visual circuit 208 to indicate an alarm.

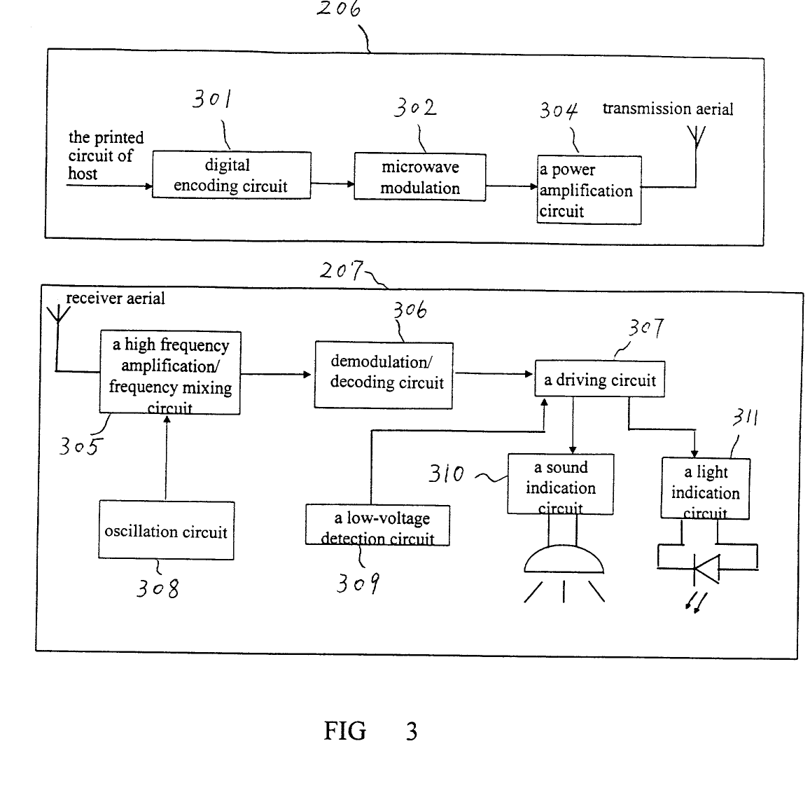

Refer now to FIG. 3. Radio transmission module 206 comprises a digital encoding circuit 301, a microwave modulation circuit 302 and a power amplification circuit 304. Correspondingly, the radio receiving module 207 includes a high-frequency amplification and mixing circuit 305, a demodulation/decode circuit 306 and a driving circuit 307. An oscillation circuit 308 provides an oscillation source for the high-frequency amplification and mixing circuit 305. A detecting signal from the low DC voltage detection circuit 309 is fed to an input of driving circuit 307, which, in turn, activates an audible-visual alarm circuits 310 and 311. Sound indication circuit 310 broadcasts an audio alarm while light indication circuit 311 broadcasts a visual alarm. The use of digital encoding/decoding, wherein a coded signal is transmitted to and received by radio receivers, advantageously eliminates or reduces the effects of radio interference so as to prevent or substantially reduce the likelihood of an incorrect alarm signal being generated by the radio receiver.

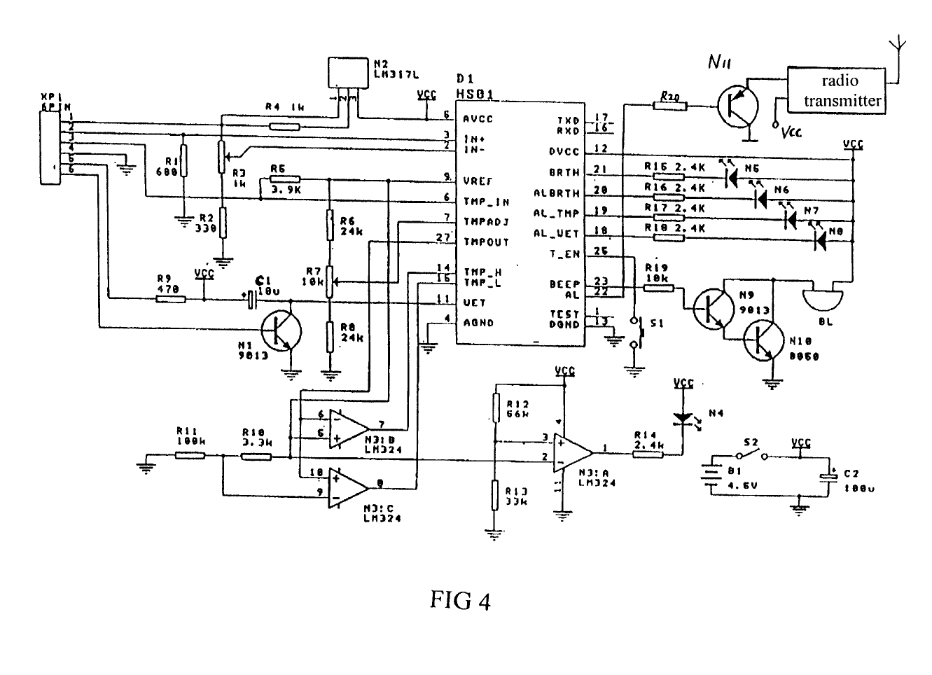

Refer now to FIG. 4 that illustrates the electrical circuit on the circuit board 7 in accordance with a disclosed embodiment of the present invention. As a core portion for realizing the functions of the present invention, module HS01 is employed for processing sensed data. A program stored in its memory is used to compare inputted new data with stored data, which will not be covered or updated by new data until it has been reserved for a predetermined time. The analytical result will determine whether or not the infant is in a normal status.

Breathing sensor 1 and urinary wetness sensor 2 are connected to circuit board 7 via connecting pins XP1. More particularly, input terminals 2, 3 and 6 of module HS01 are coupled to the output of breathing sensor 1. Input terminal 11 of module HS01 receives outputted signals from urinary wetness sensor 2 via the urinary wetness detecting circuit 203, which is comprised of R9, C1 and N1. While output terminals 23, 18 and 19 are used to activate the audible-visual alarm circuit 204, output terminal 22, via resistor R20 and triode N11, is connected to radio transmission module 206 for energizing the radio alarm signal. The constant current source circuit 202, composed of voltage stabilization integrated circuit N2 and resistor R4, provides breathing sensor 1 with a constant current.

Terminal 6 of module HS01 is used for recognizing the appearance of breathing sensor 1. If no breathing sensor is connected, module HS01 will operate only for detecting urinary wetness. When the urinary wetness reaches predetermined threshold, which can be detected by input terminal 11 of module HS01, an alarm signal will be initiated. LEDs (light emitting diodes) N5, N6, N7 and N8 are used for indicating the status of the infant. In particular, LED N5 is designed for indicating the rhythm of breathing, while LEDs N6 and N7 will be lit when abnormal breathing occurs. When urinary wetness exceeds a predetermined threshold, LED N8 will be lit as well.

An audio alarm circuit, comprised of R19, N9, N10 and BL, will operate to sound an alarm. Simultaneously, the radio transmission module will be activated to send a radio alarm signal. In a preferred embodiment of the present invention, a power supply is provided with “AA”sized batteries with a switch S2 for turning on/off the system.

Thus, it is apparent that, based on the present invention, a reliable, convenient infant monitoring system can be provided that is capable of detecting both apnea and urinary wetness of an infant by using one integrated device, and then signal an alarm in a local site and to remote receivers when predetermined conditions occur. Consequently, the system can meet the requirement for monitoring the infant, greatly reducing workload of family members and nursing professionals. In addition, the system is convenient to use.

While particular embodiments of the present invention have been shown and described, it will be obvious to those skilled in the art that changes and modifications may be made without departing from this invention in its broader aspects and, therefore, the aim in the appended claims is to cover all such changes and modifications as fall within the true spirit and scope of this invention. For example, while it is intended that the present invention be used to monitor infants, it is also applicable for others, such as the elderly, who are unable to care for themselves. Indeed, it is also conceivable that the present invention be used for monitoring animals, such as pets, whose owners desire such capability.

We claim:

1. A monitoring system for detecting breathing and urination of an entity comprising:
a breathing sensor for sensing said entity's breathing;
a urinary wetness sensor for detecting urination of said entity; and
a device for receiving and analyzing sensed data from said breathing sensor and urinary wetness sensor.

2. The monitoring system of claim 1 wherein said device activates an alarm when a predetermined condition of said entity occurs.

3. The monitoring system of claim 2 wherein said alarm is a visual one.

4. The monitoring system of claim 2 wherein said alarm is an audible one.

5. The monitoring system of claim 2 wherein said device activates at least one signal indicative of a normal condition of said entity.

6. The monitoring system of claim 5 wherein said signal is one that alternates with the breathing of said entity.

7. The monitoring system of claim 1 further comprising a radio transmission module responsive to said device and at least one radio receiver responsive to said radio transmission module, and wherein said device controls the sending of at least one signal from said radio transmission module to said at least one radio receiver.

8. The monitoring system of claim 7 wherein said radio transmission module transmits and said radio receiver receives an encoded signal.

9. The monitoring system of claim 7 wherein said radio receiver module sends signal to an associated alarm circuit that generates an alarm.

10. The monitoring system of claim 9 wherein said alarm is a visual one.

11. The monitoring system of claim 9 wherein said alarm is an audible one.

12. A method for monitoring breathing and urination of an entity comprising the steps of:
sensing breathing and urination of said entity at different times and generating data therefrom;
comparing said data at one time with data from another time; and
generating an alarm signal when said comparing step provides a first result.

13. A monitoring system for detecting status of an entity comprising:
a breathing sensor for monitoring breathing rhythms of said entity;
a urinary wetness sensor for detecting urination of said entity; and
a processing device having a radio transmission module for sending a radio alarm signal to at least one remote receiver, and a circuit board for receiving and analyzing sensed data from said breathing sensor and said urinary wetness sensor;
wherein said circuit board will activate an audible-visual alarm circuit to produce an alarm and drive said radio transmission module to send out a radio alarm signal when said sensed data reaches predetermined threshold.

14. The monitoring system of claim 12 wherein said breathing sensor is housed inside a soft enclosure which is applied to the entity's abdomen with a strap.

15. The monitoring system of claim 12 wherein said radio transmission signal is digitally encoded so as to prevent said radio receiver from being inappropriately activated.

16. The monitoring system of claim 12 wherein said circuit board includes an IC module, a urinary wetness detecting circuit, an audible-visual alarm circuit, and wherein outputs of said breathing sensor and said urinary wetness sensor are fed to corresponding inputs of said IC module and at least one output of said IC module is fed to said audible-visual alarm circuit and said radio transmission module.
